(19) United States
(12) Patent Application Publication
(10) Pub. No.: US 2018/0358866 A1
(43) Pub. Date: Dec. 13, 2018

(54) BEARING PLATE FOR A BRUSHLESS DC MOTOR AND MANUFACTURING METHOD FOR A BEARING PLATE FOR A BRUSHLESS DC MOTOR

(71) Applicant: Robert Bosch GmbH, Stuttgart (DE)

(72) Inventors: Axel Kiersten, Oberstenfeld (DE); Janos Tamas Csoti, Karlsruhe (DE); Roman Koch, Waldbronn (DE)

(21) Appl. No.: 16/001,406

(22) Filed: Jun. 6, 2018

(30) Foreign Application Priority Data
Jun. 8, 2017 (DE) 102017209635.7

(51) Int. Cl. H02K 7/08; H02K 7/10; H02K 15/00; H02K 3/28; B60T 13/74

(52) U.S. Cl. CPC H02K 7/08; H02K 7/10; B60T 13/74; H02K 3/28; H02K 15/0056

(57) ABSTRACT

A bearing plate for a brushless DC motor which is installable on and/or in the brushless DC motor and which includes a bearing receptacle opening into which a bearing of the brushless DC motor is insertable or inserted, the bearing plate including at least one busbar which is fastened on and/or in the bearing plate and which is configured so that the motor coils of the brushless DC motor are interconnected with one another via the particular busbar of the bearing plate installed on and/or in the brushless DC motor. Also described are a brushless DC motor and an electromechanical braking device for a vehicle, and a manufacturing method for a bearing plate for a brushless DC motor.

### RELATED APPLICATION INFORMATION

The present application claims priority to and the benefit of German patent application no. 10 2017 209 635.7, which was filed in Germany on Jun. 8, 2017, the disclosure which is incorporated herein by reference.

### FIELD OF THE INVENTION

The present invention relates to a bearing plate for a brushless DC motor. The present invention also relates to a brushless DC motor and an electromechanical braking device for a vehicle. Furthermore, the present invention relates to a manufacturing method for a bearing plate for a brushless DC motor.

### BACKGROUND INFORMATION

Patent document DE 10 2015 226 721 A1 discusses an electric motor which is equipped with an A-side bearing shield and a B-side bearing shield, an A-side bearing being installed on the A-side bearing shield and a B-side bearing being installed on the B-side bearing shield. Moreover, the electric motor includes an interconnection ring for interconnecting the motor coils of the electric motor.

### SUMMARY OF THE INVENTION

The present invention provides a bearing plate for a brushless DC motor having the features described herein, a brushless DC motor having the features described herein, an electromechanical braking device for a vehicle having the features described herein, a manufacturing method for a bearing plate for a brushless DC motor having the features described herein, and a manufacturing method for a brushless DC motor having the features described herein.

The present invention allows for an interconnection/interconnecting plate (which is separate with regard to the bearing plate according to the present invention) for interconnecting the (electric) motor coils/motor windings of the particular brushless DC motor to be dispensed with. By dispensing with the (separate) interconnection/interconnecting plate, an expansion/overall length of the (complete) brushless DC motor may be reduced. In this way, the brushless DC motor implemented with the aid of the present invention may also be used for applications subject to space limitations. By omitting the (separate) interconnection/interconnecting plate, the particular brushless DC motor may likewise be produced more cost-effectively. Furthermore, when using the present invention, conventional assembly steps for assembling the (separate) interconnection/interconnecting plate on the particular brushless DC motor are dispensed with. This also simplifies a manufacture of the particular brushless DC motor.

In one advantageous specific embodiment of the bearing plate, at least one first sensor is fastened on and/or in the bearing plate and/or the bearing plate is configured to have at least one sensor receptacle opening in which at least one second sensor is insertable. The at least one first or second sensor is thus comparably easily installable as an integral part of the brushless DC motor. Moreover, the specific embodiment of the bearing plate described here may result in the brushless DC motor equipped with the at least one first or second sensor to be further minimized.

For example, the at least one first or second sensor may be a rotation angle sensor, a rotor position sensor, a motor current sensor and/or a temperature sensor. Thus, a plurality of sensor types, with the aid of which an operation of the particular brushless DC motor equipped therewith is optimizable, is installable easily and effortlessly.

In another advantageous specific embodiment of the bearing plate, at least one motor contact of the at least one busbar of the bearing plate is configured as an insulation displacement connection. The bearing plate described here may thus be easily brought in reliable contact with the motor coils/motor windings of the particular brushless DC motor.

The at least one busbar of the bearing plate may be surrounded at least partially by a plastic injection-molded part of the bearing plate, the bearing receptacle opening being formed on the plastic injection-molded part. The design of the bearing plate including the plastic injection-molded part, (at least) the bearing receptacle opening being (automatically) formed during the plastic injection-molding process, allows for this specific embodiment of the bearing plate to be manufactured easily and cost-effectively. Moreover, the at least one first sensor may be fastened on and/or in the plastic injection-molded part and/or the at least one sensor receptacle opening, into which the at least one second sensor is insertable, may be formed on the plastic injection-molded part. This refinement is also achievable without significant additional expenses during the manufacture of the bearing plate.

The advantages described above are also achieved in a brushless DC motor including a bearing plate of this type.

The brushless DC motor may be advantageously configured for operating an electromechanical braking device of a vehicle. Since the brushless DC motor is designable comparably small/having a small volume, it is relatively easily installable in the particular vehicle.

An electromechanical braking device for a vehicle including a corresponding brushless DC motor likewise yields the above-described advantages.

Carrying out a corresponding manufacturing method for a bearing plate for a brushless DC motor also yields the above-described advantages. It is expressly pointed out that the manufacturing method is refinable according to the above-described specific embodiments of the bearing plate and/or of the brushless DC motor.

Furthermore, carrying out a corresponding manufacturing method for a brushless DC motor also yields the above-named advantages. Moreover, the manufacturing method for a brushless DC motor is refinable according to the above-described specific embodiments of the bearing plate and/or of the brushless DC motor.

Additional features and advantages of the present invention are explained in the following on the basis of the figures.

### BRIEF DESCRIPTION OF THE DRAWINGS

FIGS. 1a, 1b and 1c show schematic representations of one specific embodiment of the bearing plate.

FIG. 2 shows a flow chart for explaining a specific embodiment of the manufacturing method for a bearing plate for a brushless DC motor.

### DETAILED DESCRIPTION

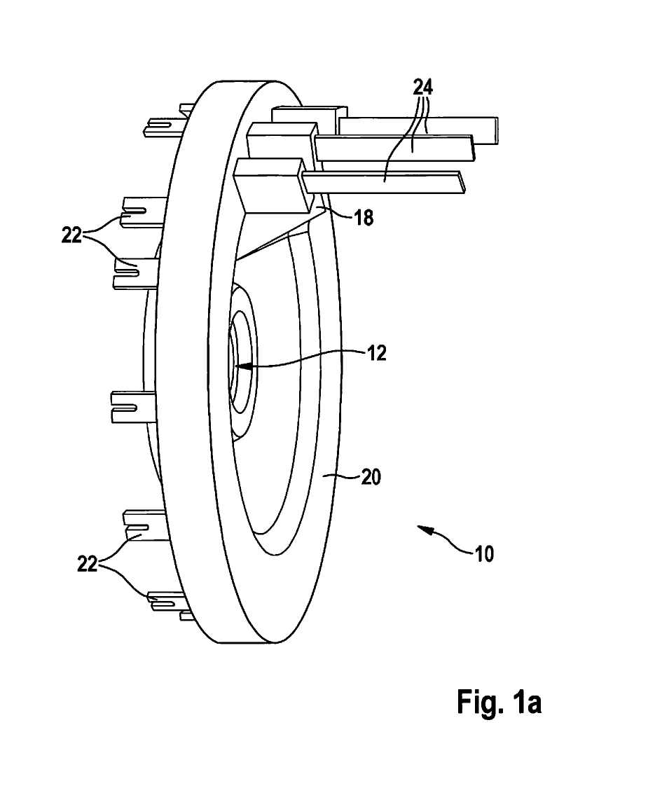

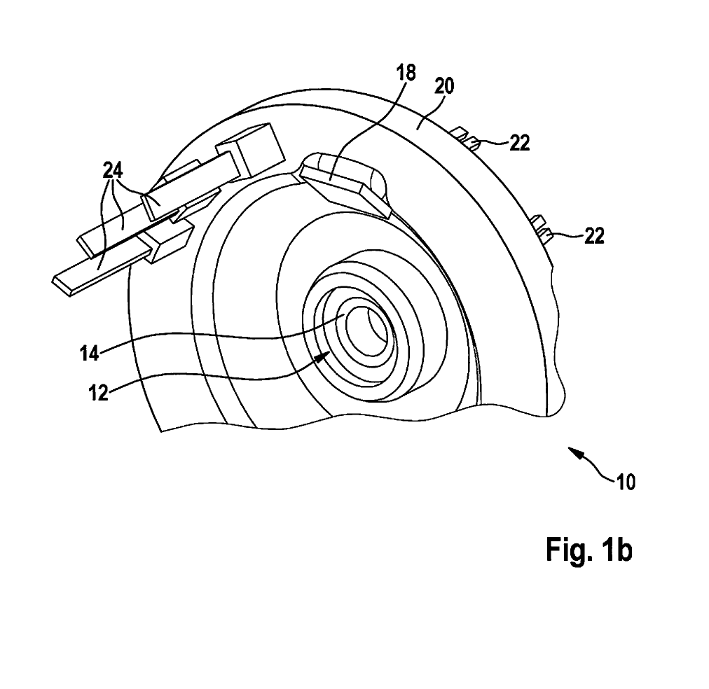

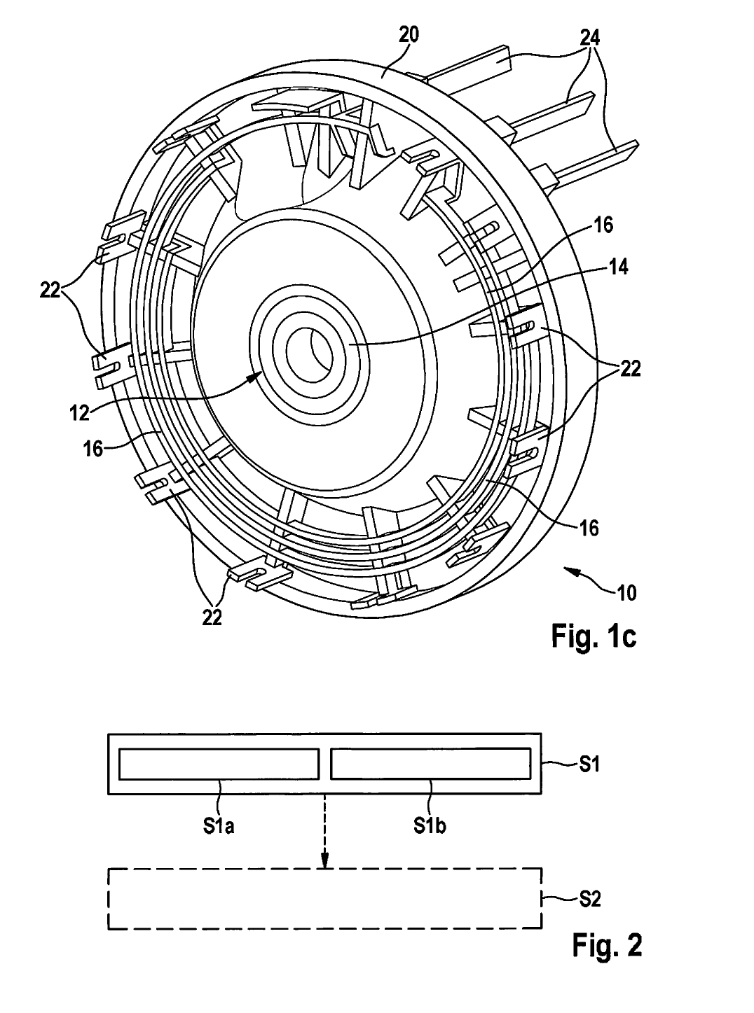

FIGS. 1a through 1c show schematic representations of one specific embodiment of the bearing plate.

Bearing plate 10 illustrated schematically in FIGS. 1a through 1c may also be referred to as a bearing cover or as a bearing shield. Bearing plate 10 is configured for use on and/or in a brushless DC motor (not illustrated). For this purpose, bearing plate 10 is installable on and/or in the brushless DC motor. It is pointed out that the usability of bearing plate 10 is not limited to a certain type of brushless DC motors. Bearing plate 10 may be installable as an A-bearing plate (A-side bearing plate) or as a B-bearing plate (B-side bearing plate), or as an A-bearing cover, a B-bearing cover, an A-bearing shield or a B-bearing shield, on the brushless DC motor.

Bearing plate 10 is configured to have a bearing receptacle opening 12 in which a bearing 14 of the brushless DC motor is insertable/inserted. (Bearing 14 does not have to be “part” of bearing plate 10.) Bearing 14 is insertable/inserted in bearing receptacle opening 12 in such a way that bearing 14, which is inserted/installed in bearing receptacle opening 12, may fulfill its standard/desirable function in the brushless DC motor. Bearing 14 is in particular insertable/installable into bearing receptacle opening 12 in such a way that bearing 14 is in (direct) contact with bearing plate 10. A form of bearing receptacle opening 12 may therefore correspond to a “shape” of bearing 14. Bearing 14 may be understood to mean an A-bearing (A-side bearing) or a B-bearing (B-side bearing). Bearing 14 may be a plain bearing or a rolling bearing, for example a ball bearing, a grooved ball bearing, an angular ball bearing, a separable ball bearing, a self-aligning ball bearing, a roller bearing, a tapered roller bearing, a cylindrical roller bearing, a spherical roller bearing, a self-aligning roller bearing, a toroidal roller bearing, a needle bearing, a radial bearing, a 4-point bearing, an axial bearing, or a thrust bearing. An implementability of bearing plate 10 is thus not limited to a certain bearing type of bearing 14 insertable/inserted in bearing receptacle opening 12.

Bearing plate 10 also includes at least one busbar 16 fastened (directly) on and/or in bearing plate 10, the at least one busbar 16 being configured in such a way that the motor coils/motor windings of the brushless DC motor are interconnected with one another via particular busbar 16 of bearing plate 10 which is installed on and/or in the brushless DC motor. Two opposite motor coils/motor windings may be interconnected with one another in each case with the aid of assigned busbar 16 (of bearing plate 10 installed on and/or in the brushless DC motor). Bearing plate 10 therefore does not only fulfill the “bearing-holding function” (of a conventional bearing plate), but also the “interconnecting function” for interconnecting the motor coils/motor windings (of a conventional interconnecting plate). Bearing plate 10 may thus be referred to as a multifunction bearing plate or a bearing and interconnecting plate. By utilizing bearing plate 10, a (separate/additional) interconnecting plate/interconnection of the motor coils/motor windings may therefore be dispensed with. This simplifies a minimization of the brushless DC motor, including bearing plate 10, and results in work steps being saved during the motor assembly of same. Moreover, the brushless DC motor which is equipped with bearing plate 10 is manufacturable more cost-effectively.

Bearing plate 10 is configured in such a way that a spatial separation of a subunit of bearing plate 10 including bearing receptacle opening 12, and the at least one busbar 16 of bearing plate 10 is not achievable without an irreversible fragmentation of bearing plate 10 (for example, a breaking/destruction of bearing plate 10). Bearing plate 10 is thus a compact bearing plate 10 (despite it being implemented as a multifunction bearing plate or a bearing and interconnecting plate).

Bearing plate 10 which is schematically illustrated in FIGS. 1a through 1c also includes at least one sensor 18 which is fastened (directly) on and/or in bearing plate 10. As a refinement (not illustrated), at least one shielding plate may also be situated on and/or in bearing plate 10 with the aid of which the at least one sensor 18 is shielded from a motor magnetic field. In the specific embodiment of FIGS. 1a through 1c, (the sole) sensor 18, is a rotation angle sensor/rotor position sensor 18, by way of example. Bearing plate 10 may, however, also be equipped with multiple sensors 18 and other sensor types, for example a motor current sensor and/or a temperature sensor. Alternatively or additionally to the at least one sensor 18 which is fastened on and/or in bearing plate 10, bearing plate 10 may also include at least one sensor receptacle opening (not illustrated), into which at least one (additional) sensor is insertable/installable. In this case, the at least one (additional) sensor is insertable/installable into the at least one sensor receptacle opening in such a way that the at least one (additional) sensor is in (direct) contact with bearing plate 10. A form of the at least one sensor receptacle opening may correspond to a “shape” of the at least one (additional) sensor. Adjacent to the at least one sensor receptacle opening, at least one shielding plate may also be integrated into bearing plate 10, for the purpose of shielding the at least one (additional) sensor, which is installed in the at least one sensor receptacle opening, from the motor magnetic field. All the sensor types listed above may be insertable/installable into the at least one sensor receptacle opening. It is moreover pointed out that an implementability/equipability of bearing plate 10 is not limited to the sensor types listed above.

By integrating the at least one sensor 18 on and/or in bearing plate 10, and by correspondingly forming the at least one sensor receptacle opening on bearing plate 10, higher positioning accuracy may be achieved for the at least one fastened or inserted sensor 18. A minimization of the implemented brushless DC motor may likewise be achieved in this way and assembly steps may be saved or simplified during the assembly of same.

A spatial separation of the at least one sensor 18 and/or of a subunit including the at least one sensor receptacle opening from the subunit including bearing receptacle opening 12, and the at least one busbar 16 is not achievable without an irreversible fragmentation of bearing plate 10 (for example, a breaking/destruction of bearing plate 10). Even if bearing plate 10 is configured to have at least one sensor 18 and/or at least one sensor receptacle opening, a compact bearing plate 10 is still provided.

In the case of bearing plate 10 of FIGS. 1a through 1c, the at least one busbar 16 of bearing plate 10 is surrounded at least partially by a plastic injection-molded part 20. Bearing receptacle opening 12 is formed (directly/as a “shape”) on plastic injection-molded part 20. Moreover, the at least one sensor 18 is (directly) fastened on and/or in plastic injection-molded part 20. Alternatively or additionally, the at least one sensor receptacle opening into which the at least one (additional) sensor is insertable may be formed (directly/as a “shape”) on plastic injection-molded part 20. For plastic injection-molded part 20, a plastic may be used which is cost-effective and easily deformable with the aid of an injection-molding process. Bearing plate 10 including plastic injection-molded part 20 is therefore manufacturable easily and cost-effectively. Instead of plastic injection-molded part 20, bearing plate 10 may, however, also be formed (at least partially) of deep-drawn steel.

The at least one busbar 16 may be formed from at least one electrically conductive material. For example, the at least one busbar 16 may be at least one copper bar. At least one motor contact 22 of the at least one busbar 16 may ensure a reliable interconnection of the motor coils/motor windings. The at least one motor contact 22 may be configured as an insulation displacement connection. The particular insulation displacement connection may either be directly extrusion-coated using the plastic of plastic injection-molded part 20 or fastened with the aid of a catch. Bearing plate 10 of FIGS. 1a through 1c also includes one interconnecting contact 24 each per busbar 16.

The advantages of above-described bearing plate 10 also result in the case of a brushless DC motor including bearing plate 10 (which is implemented, for example, for operating an electromechanical braking device of a vehicle/motor vehicle), i.e. for the electromechanical braking device for a vehicle/motor vehicle. The electromechanical braking device may be, for example, understood to mean a power brake, an electromechanical brake booster (upstream from a brake master cylinder), a pump system including at least one pump or a motorized piston/cylinder device (a plunger). The examples listed here for the electromechanical braking device are, however, not to be understood as being definitive.

FIG. 2 shows a flow chart for explaining one specific embodiment of the manufacturing method for a bearing plate for a brushless DC motor.

In one method step S1, the bearing plate is deformed in such a way that the (completed) bearing plate is installable on and/or in the brushless DC motor. Method step S1 includes at least substeps S1a and S1b, in substep S1a at least one busbar being fastened on and/or in the bearing plate in such a way that the motor coils of the brushless DC motor are interconnected with one another via the particular busbar of the bearing plate installed on and/or in the brushless DC motor. Moreover, in substep S1b, the bearing plate includes a bearing receptacle opening into which a bearing of the brushless DC motor is insertable/inserted.

Substeps S1a and S1b may be carried out in an arbitrary sequence, simultaneously or chronologically overlapping. In addition, the features explained in the description of the preceding specific embodiment are implemented in method step S1 on the bearing plate.

In one optional method step S2, a bearing plate manufactured according to the above-described method may be installed on and/or in the brushless DC motor. The method described here may thus be expanded to include a manufacturing method for a brushless DC motor.

What is claimed is:

1. A bearing plate for a brushless DC motor which is installable on and/or in the brushless DC motor, comprising:
a bearing receptacle opening into which a bearing of the brushless DC motor is insertable or inserted; and
at least one busbar which is fastened on and/or in the bearing plate and which is configured so that motor coils of the brushless DC motor are interconnected with one another via the particular busbar of the bearing plate installed on and/or in the brushless DC motor.

2. The bearing plate of claim 1, wherein at least one first sensor is fastened on and/or in the bearing plate, and/or wherein the bearing plate includes at least one sensor receptacle opening into which at least one second sensor is insertable.

3. The bearing plate of claim 2, wherein the at least one first sensor or the at least one second sensor includes a rotation angle sensor, a rotor position sensor, a motor current sensor and/or a temperature sensor.

4. The bearing plate of claim 1, wherein at least one motor contact of the at least one busbar of the bearing plate is configured as an insulation displacement connection.

5. The bearing plate of claim 1, wherein the at least one busbar of the bearing plate is surrounded at least partially by a plastic injection-molded part of the bearing plate and the bearing receptacle opening is formed on the plastic injection-molded part.

6. The bearing plate of claim 5, wherein the at least one first sensor is fastened on and/or in the plastic injection-molded part and/or the at least one sensor receptacle opening, into which the at least one second sensor is insertable, is formed on the plastic injection-molded part.

7. A brushless DC motor, comprising:
a bearing plate, including:
a bearing receptacle opening into which a bearing of the brushless DC motor is insertable or inserted; and
at least one busbar which is fastened on and/or in the bearing plate and which is configured so that motor coils of the brushless DC motor are interconnected with one another via the particular busbar of the bearing plate installed on and/or in the brushless DC motor.

8. The brushless DC motor of claim 8, wherein the brushless DC motor is configured for operating an electromechanical braking device of a vehicle.

9. An electromechanical braking device for a vehicle, comprising:
a brushless DC motor, including a bearing plate, wherein the bearing plate includes:
a bearing receptacle opening into which a bearing of the brushless DC motor is insertable or inserted; and
at least one busbar which is fastened on and/or in the bearing plate and which is configured so that motor coils of the brushless DC motor are interconnected with one another via the particular busbar of the bearing plate installed on and/or in the brushless DC motor;
wherein the brushless DC motor is configured for operating an electromechanical braking device of a vehicle.

10. A manufacturing method for a bearing plate for a brushless DC motor, the method comprising:
forming the bearing plate so that the bearing plate is installable on and/or in the brushless DC motor, the bearing plate including a bearing receptacle opening into which a bearing of the brushless DC motor is insertable; and
fastening at least one busbar on and/or in the bearing plate so that the motor coils of the brushless DC motor are interconnected with one another via a particular busbar of the bearing plate installed on and/or in the brushless DC motor.

11. A manufacturing method for a brushless DC motor, the method comprising:
installing a first bearing plate or a second bearing plate on and/or in the brushless DC motor;
wherein the first bearing plate includes:
a bearing receptacle opening into which a bearing of the brushless DC motor is insertable or inserted; and
at least one busbar which is fastened on and/or in the bearing plate and which is configured so that motor coils of the brushless DC motor are interconnected with one another via the particular busbar of the bearing plate installed on and/or in the brushless DC motor; and
wherein the second bearing plate is made by performing the following:
forming the bearing plate so that the bearing plate is installable on and/or in the brushless DC motor, the bearing plate including a bearing receptacle opening into which a bearing of the brushless DC motor is insertable; and
fastening at least one busbar on and/or in the bearing plate so that the motor coils of the brushless DC motor are interconnected with one another via a particular busbar of the bearing plate installed on and/or in the brushless DC motor.
